(19) United States
(12) Patent Application Publication
(10) Pub. No.: US 2009/0276162 A1
(43) Pub. Date: Nov. 5, 2009

(54) SENSOR DEVICE AND SENSOR SYSTEM

(75) Inventors: Reinhard VIGA, Krefeld (DE); Gudrun STOCKMANNS, Krefeld (DE); Anton GRABMAIER, Moers (DE); Hans-Dieter KOCHS, Krefeld (DE)

Correspondence Address: Jason H. Vick;Sheridan Ross, PC, Suite # 1200, 1560 Broadway, Denver, CO, 80202, US

(73) Assignee: UNIVERSITAT DUISBURG-ESSEN, Essen (DE)

(21) Appl. No.: 12/465,366

(22) Filed: May 13, 2009

Related U.S. Application Data
(63) Continuation-in-part of application No. PCT/EP2007/009895, filed on Nov. 15, 2007.

(30) Foreign Application Priority Data
Nov. 15, 2006 (DE) 102006054219.3

(51) Int. Cl. G06F 19/00

(52) U.S. Cl. 702/19; 702/188

(57) ABSTRACT

The invention relates to a sensor device for fastening to human or animal bodies and to a sensor system comprising a plurality of said sensor devices. The sensor devices each comprise a sensor element and a transmission device for the wireless transmission of sensor signals to a receiving device of the sensor system. Thus, universal usability and particularly the suitability to carry out biopotential measurements preferably with automatic detection of configurations is made possible in that the sensor devices each are provided with a connecting device for the electrical connection to a neighboring sensor device and/or a position detection device for detecting the position relative to the neighboring sensor unit.

### CROSS-REFERENCE TO RELATED APPLICATION

This application is a Continuation-in-Part application under 35 U.S.C. 111(a) and claims priority to PCT Application PCT/EP2007/009895, filed 15 Nov. 2007, which claims priority to German Application, 10 2006 054 219.3, filed 15 Nov. 2006, all of which are incorporated herein by reference in their entirety.

### SUMMARY OF THE INVENTION

The present invention relates to a sensor device according to the preamble of claim 1, 10, 13 or 18 as well as a sensor system comprising a plurality of such sensor devices.

The present invention is concerned with sensor devices for in particular only external fastening to the human and/or animal body. The sensor devices have sensor elements for detecting physical properties of the human or animal body. The values detected by the sensor elements or values derived therefrom, subsequently designated in summary as “sensor signals”, are transmitted in a wireless manner to a receiving device for further processing, display, (further) evaluation, storage or the like. For example, EEG, ECG, EOG or EMG signals can be detected with these sensor devices. However, such sensor devices can be used in principle for detecting any kind of physical quantities or measured values of the human or animal body.

The present invention is concerned in particular with sensor devices each comprising a sensor element and an associated transmission device for the wireless transmission of sensor signals to the receiving device, wherein the preferably exchangeable sensor element and the transmission device form a structural or handling unit. The individual sensor devices can preferably be used autonomously.

DE 103 01 225 A1, which forms the starting point of the present invention, discloses a sensor system having a plurality of sensor devices which transmit the sensor signals in a wireless manner. The sensor devices each comprise a sensoric component as sensor element and an electronic component with a transmission device for the wireless transmission of sensor signals. The sensor signals are transmitted in a wireless manner to receiving modules which are assigned to a specified medical appliance. The signal evaluation is preferably effected in the medical appliance. In order to be able to distinguish the individual sensor devices and sensor elements, corresponding identifications are preferably provided and can be transmitted. If necessary, the sensor devices can be provided with position sensors in order to be able to detect whether the sensor devices are located in their operating position, for example on the body of a patient or the like. In particular, these position sensors are configured as mechanical buttons but can also determine the correct distance or contact, or the correct position, in a non-contact manner. Despite the aforesaid measures, it is particularly problematical to carry out biopotential measurements.

It is the object of the present invention to provide a sensor device and a sensor system comprising a plurality of sensor devices, whereby simple and/or particularly universal usability is made possible and/or measurement errors or application errors in measurements particularly of biopotentials on the human and/or animal body can be better avoided.

The above object is achieved by a sensor device according to claims 1, 10, 13 or 18 or by a sensor system according to claim 24 or 26. Advantageous further developments are the subject matter of the dependent claims.

According to a first aspect of the present invention, additionally to the transmission device, the sensor device has a connecting device for cable-bound and/or electrical connection to a neighboring sensor device, particularly of the same type. Particularly preferably, the connecting device permits electrical coupling of neighboring sensor devices during their usage or after their application to the human or animal body, in particular if the sensor devices are arranged at a distance from one another or in a distributed manner. It is therefore very easily possible to connect the sensor devices electrically to one another. However, the transmission of sensor signals to the (common or central) receiving device is effected in a wireless manner by means of the transmission device(s).

Accordingly, measurements can be carried out, that is, possible errors can be avoided, with higher accuracy and/or reliability.

The electrical connection of the neighboring sensor devices in particular permits a common reference potential in potential measurements such as are carried out in particular when using electrodes as sensor elements or in EEG, ECG, EOG or EMG measurements and/or when leading off in particular acoustically evoked potentials, continuous monitoring or the like. Alternatively or additionally, the direct connection of neighboring sensor devices can also be used for signal or data exchange. Particularly preferably in this case it can be detected and/or monitored whether intercoupled sensor devices, in particular pairs of sensor devices, are working correctly, have correct contact to the human or animal body or the like. This is particularly important in biopotential measurements with electrodes as sensor elements in order to be able to detect and evaluate differential voltages between the individual potentials detected by the electrodes.

A second, also independently achievable aspect of the present invention consists in that the sensor devices have a position detection device for detecting their position relative to one another. Such a position detection device is important for the direct assignment of the sensor devices to one another. In particular, it is thus possible that a sensor system as proposed or its receiving device independently detects, checks and/or evaluates a specified arrangement or interconnection of sensor devices, particularly preferably for the unipolar or bipolar leading-off of potentials as desired. This makes it possible to achieve a substantial improvement in safety when using the sensor devices as proposed or the sensor system as proposed. In particular, faulty circuits or incorrect wiring or the like can thus be avoided and errors can be avoided accordingly.

Each sensor device particularly preferably forms a structural or at least handling unit. This permits very simple handling whereby the attachment and the connection or the making of connections is substantially facilitated. The sensor elements are in this case preferably connected both mechanically and electrically to the respective sensor device.

The sensor elements are preferably exchangeable or replaceable and are particularly preferably configured or used as disposable articles.

According to a third, also independently achievable aspect of the present invention, alternatively or additionally to the preferably only passively operating sensor elements, actively operating sensor elements or other active devices, in particular for producing an evoked signal in the respective patient, can be coupled to the sensor devices, preferably both mechanically and electrically, particularly preferably to a corresponding generator and/or amplifier device or the like of the respective sensor device.

According to a fourth, also independently achievable aspect of the present invention, the reference potential for potential measurements of the sensor devices can be controlled or regulated by a sensor device. In particular, the sensor device as proposed is configured in such a manner that a control or regulation of the reference potential takes place or does not take place as desired. In particular, the control or regulation of the reference potential of the individual sensor devices can be switched on and off or activated as required and/or by remote control. This is conducive to universal usability, permits easy handling and/or can avoid measurement errors.

### BRIEF DESCRIPTION OF THE DRAWINGS

Further advantages, aspects, features and properties of the present invention are obtained from the claims and from the following description of a preferred embodiment with reference to the drawings. In the figures:

FIG. 1 shows a schematic diagram of a sensor system as proposed comprising sensor devices as proposed in a first arrangement on a human body;

FIG. 2 shows a schematic diagram corresponding to FIG. 1 of the sensor system as proposed comprising the sensor devices as proposed in a second arrangement on a human body;

FIG. 3 shows a block-diagram-like sectional view of a sensor device with a first sensor element; and

FIG. 4 shows a block-diagram-like sectional view of a sensor device with a second sensor element.

In the figures the same reference numerals are used in each case for the same parts and components, whereby corresponding advantages and properties are obtained even if a repeated description is omitted.

### DETAILED DESCRIPTION OF THE INVENTION

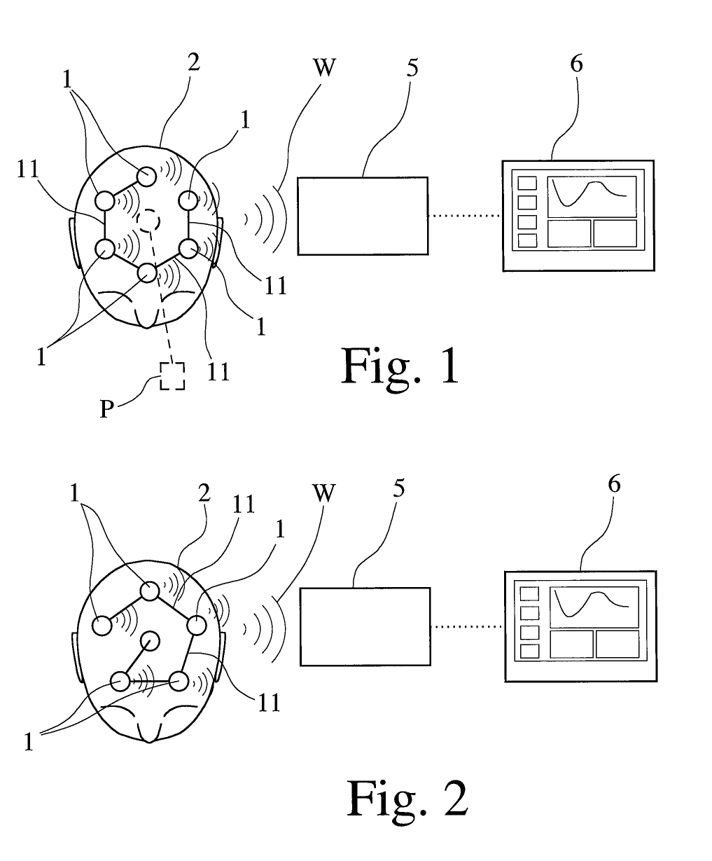

The schematic diagram according to FIG. 1 shows a sensor system as proposed with a plurality of sensor devices 1 as proposed, which are fastened in a first arrangement externally on a human or animal body 2, in this case a head. For this purpose the sensor devices 1 preferably have an integrated fastening device B as required (in this case in particular a suction pad, an adhesion element or the like) or can be fastened by external means, for example, a gel, a plaster or the like, in a desired manner on the body 2.

The attachment or fastening of the sensor device 1 is preferably only effected externally on the body 2. In principle, however, any other fastening is possible.

FIG. 2 shows another arrangement of the sensor devices 1 on the body 2 in a diagram corresponding to FIG. 1.

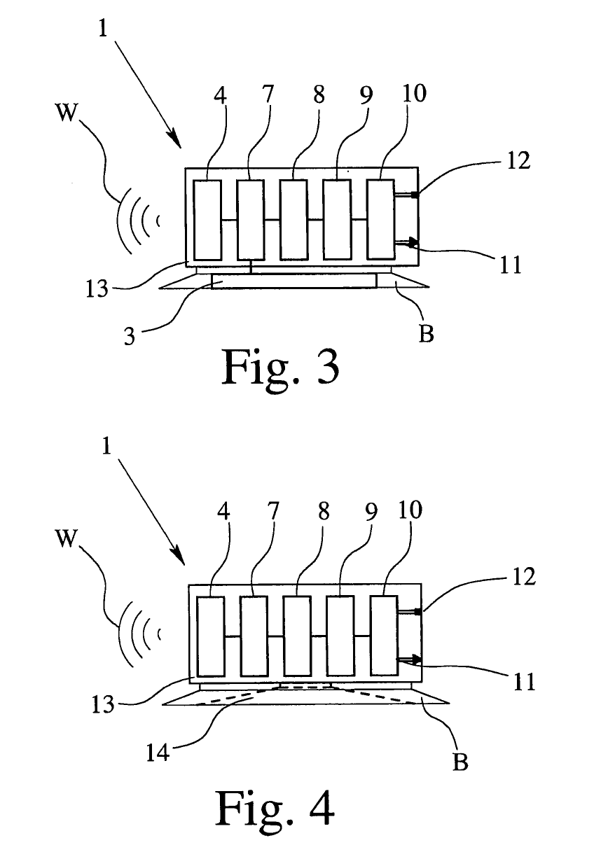

FIG. 3 shows a single sensor device 1 in a sectional or block-diagram-like, also schematic view. The sensor device 1 comprises a sensor element 3 which is configured in particular as an electrode. In the exemplary diagram, the sensor element 3 forms a passive component. In principle, however an active element can also be used as a sensor element 3.

The sensor element 3 is preferably connected or can be connected both mechanically and electrically to the sensor device. In particular, the sensor element 3 with the sensor device 1 forms a structural or handling unit, at least in the usage state shown.

The sensor element 3 of the sensor device 1 is particularly preferably detachable or exchangeable. In particular, the sensor element 3 comprises a disposable article which is preferably exchanged or replaced after every use.

The sensor device 1 has a transmission device 4 for the wireless transmission, as indicated by waves W in the figure, of sensor signals to a receiving device 5 of the sensor system as proposed or the like. The transmission device 4 can transmit the sensor signals in the sense initially specified, i.e. signals of the associated sensor element 3 or signals which are derived therefrom, prepared or processed, in a leadless manner.

The wireless transmission is effected in particular according to a usual standard such as WLAN, Bluetooth, ZigBee, GSM, DECT, in particular a corresponding application profile or the like, preferably therefore via radio and/or in any other suitable manner.

The wireless transmission is used in particular for spatial bridging, preferably of at least 1 m, from the respective sensor device 1 to the spatially separated receiving device 5. In particular, the receiving device 5 is not in any mechanical or conductive contact with the individual sensor devices 1. Accordingly, in particular there is no interfering wiring or the like. Furthermore, a galvanic separation of patient or sensor devices 1 on the one hand and the receiving device 5 or other equipment connected thereto on the other hand is achieved.

The receiving device 5 is configured for the wireless reception of sensor signals. A single receiving device 5 as preferably provided or a plurality of receiving devices 5 can be used.

In addition to receiving the sensor signals, the receiving device 5 is also used in particular, for the display, further processing, evaluation, storage, relaying and/or the like of the sensor signals. In the exemplary diagram a display 6 or the like is connected to the receiving device 5, as is indicated in FIGS. 1 and 2.

The sensor devices 1 are preferably configured in such a manner that the sensor signals delivered by them can be received, detected or evaluated universally by various detection devices 5. This permits very universal usage of the sensor devices 1. In particular, the sensor devices 1, once attached to the body 2, can also be used without changing over various treatment stages, during transport, during admission to a hospital, during the operation, subsequently at the intensive care unit and/or during the further aftercare.

In addition to the transmission device 4, each sensor device 1 preferably has an amplifier device 7, a power supply device 8, a position detection device 9 and/or a connecting device 10.

The amplifier device 7 is used in particular for the detection, amplification and/or processing of signals of the associated sensor element 3. In particular, the amplifier device 7 provides the amplified or processed signals as sensor signals, which can be transmitted in a wireless manner by the transmission device 4.

Alternatively or additionally, the amplifier device 7 or the sensor device 1 can also contain a memory or the like in order to be able to store the measured and/or processed signals, in particular until a transmission to the receiving device 5.

The power supply device 8 is used preferably exclusively for supplying current or power to the respective sensor device 1 and in particular has an energy storage device such as a rechargeable battery, a battery or a capacitor. The power supply device 8 or the energy storage device can preferably be charged in a wireless manner, particularly preferably inductively.

The position detection device 9 is configured in particular for the active detection of the position of the sensor device 1, preferably relative to a neighboring sensor device 1 and/or relative to any other reference object, such as a marking—e.g. attached to the head—as schematically indicated in FIG. 1 by a dashed circle. This marking could be or contain e.g. a magnetic means or body, an RFID, a light pattern or the like.

Preferably, the position device 9 is configured for determining or assisting in determining the relative or absolute spatial position of one or all sensor devices 9 or any other component.

The position device 9 can form part or be contained in one or multiple or all of the sensor devices 1. However, one position device 9 or some or all of them or part thereof can also be separate from the sensor device(s) 1 as indicated schematically in FIG. 1 by a dashed circle and/or be formed by the detection device 5.

Further relevant details and possible configurations will be explained subsequently.

Alternatively or additionally, the position detection device 9 can also be configured for the passive detection of the position, in particular as a marking with defined properties such as defined color, shape, defined reflectivity, conductivity, magnetic behavior or the like.

The connecting device 10 is preferably configured for cable- or wire-bound and/or electrical connection of the sensor device 1 to a neighboring sensor device 1, in particular of the same type. The sensor device 1 has the connecting device 10 according to the first aspect of the present invention in addition to the transmission device 4.

The connecting device 10 is configured in particular for directed electrical connection to produce a common reference potential with the neighboring sensor device 1.

In the exemplary diagram the connecting device 10 has a preferably non-detachable and/or extendable connecting cable 11 and in particular a connection 12 for a connecting cable 11 of another or neighboring sensor device 1. By means of the connecting devices 10 or connecting cable 11, the sensor devices 1 in particular therefore can be connected in accordance with the configurations shown in FIGS. 1 and 2 or electrically to one another. FIG. 1 shows a so-called bipolar lead, FIG. 2 shows a so-called unipolar lead. Such configurations are particularly appropriate when using sensor elements 3 in the form of electrodes or in biopotential measurements. However, fundamentally different configurations and arrangements and/or other design realizations are also possible amongst one another to produce the preferred electrical connection of the sensor devices 1.

A particularly preferred configuration is characterized in that the connecting cable 11 can be wound up or received independently by the sensor device 1, in particular a corresponding spring or the like not shown. The connecting cable 11 can then be extended to the desired length and in particular can be connected via the connection 12 of the neighboring sensor device 1 to the neighboring sensor device 1. A very simple and rapid method which can be implemented with little effort is thus obtained for making the desired electrical connection between the sensor devices 1.

The sensor device 1 is particularly preferably configured to detect connection data. These connection data reproduce in particular the existence of an electrical connection of the sensor device 1 with a neighboring sensor device 1 and/or properties of the connection. The connection data can preferably be transmitted from the transmission device 4 to the receiving device 5.

The neighboring or electrically connected sensor device is preferably constructed “of the same type”. This means that in particular, two, a plurality of, or all the sensor devices 1 can be identically configured but these and/or their sensor elements 3 at least have different identifiers, identifications or the like which are transmitted to the receiving devices 5 in particular together with the sensor signals and make it possible to distinguish the sensor devices 1 or sensor element 3.

The individual devices 4 and 7 to 10 of the sensor device 1 preferably, at least insofar as these are present, a structural or handling unit and in particular arranged in a common housing 13 of the sensor device 1 or accommodated thereby.

The housing 13 is preferably configured to receive or for connection of the sensor element 3 and for this purpose has a corresponding recess or other connection possibility for the sensor element 3 on the fastening side facing the body 2. In particular, the sensor device 1 or its housing 13 is configured in such a manner that the desired both mechanical and electrical connection of the sensor element 3 to the other devices 4, 7 to 10, in particular to the amplifier device 7, of the sensor device 1 is made possible.

As has already been mentioned, various kinds or types of sensor elements 3 can be used. Electrodes are particularly preferably used as sensor elements 3. In particular biopotentials, i.e. electrical voltages are detected by means of such electrodes. However, the electrodes can also be used for applying electric fields or for introducing electrical or electromagnetic signals.

In principle, the sensor devices 1 or sensor elements 3 are configured and used in particular for measurement of electrical, magnetic, acoustic or optical values or signals.

If necessary, different sensor elements 3 are connected to a common sensor device 1.

Furthermore, the sensor device 1 can also be configured in such a manner that alternatively or additionally to the (passive) sensor element 3, an active, preferably electrically operable and/or controllable device 14, in particular for producing a stimulus, can be connected. It is also possible that exclusively the active device 14 can be connected or is (fixedly) connected to the sensor device 1. The active device can, for example, be an actuator or, as shown in FIG. 4, a loudspeaker or sound generator. The loudspeaker or sound generator is then in particular connected to the amplifier device 7 or another suitable device of the sensor device 1 in order, for example, to bring about a specific functional activation of brain area which can be detected by means of the sensor devices 1 and in particular can be monitored (in particular the leading off of evoked potentials). However, other usage purposes are also possible here.

The sensor device 1 is particularly preferably configured in such a manner that it is can be used universally and in particular the sensor element 3 or the active device 14 can be connected as desired.

As has already been mentioned, the connection data and/or other operating or status data of the sensor devices 1 are preferably determined and transmitted in particular to the receiving device 5. According to a particularly preferred aspect, the sensor system as proposed or the receiving device 5, the display 6 and/or another evaluation device, a computer or the like are capable of presenting, checking and/or displaying from these data the functional capability and/or functional assignment of the sensor devices 1 with respect to one another.

The position detection device 9 is preferably configured in such a manner that it can detect the distance and/or the direction of a neighboring sensor device 1 starting from another sensor device 1. This can be accomplished in particular by detecting the extension length of the connecting cable 11 and/or its main direction of extension or the like. In this case, the position detection device 9 is preferably coupled to the connecting device 10 or formed by this.

Alternatively or additionally, the position detection device 9 can also be configured for the wireless detection of the position of the sensor device 1, in particular the position of the sensor device 1 relative to a neighboring sensor device 1. This detection of position can be effected, for example, in a wireless manner, in particular by visible or infrared light, radio, magnetic fields or the like.

Preferably each sensor device 1 is equipped with a position detection device 9. If the position data from all or at least most of the sensor devices 1 are transmitted to the receiving device 5, in particular via the respective transmission device 4, an evaluation of the position data can be made.

However, there are also other possibilities. For example, the detection device 9 or part thereof or an associated reference thereof, such as a marking, can be separate from the associated sensor device 1 as indicated in FIG. 1 by the dashed circle.

According to a preferred embodiment, the position detection device 9 can also be configured to detect visible and/or infrared light. Then, it preferably includes all necessary components for the filtering, signal decoding and evaluation of light e.g. in the surrounding. Preferably, a light marking or pattern is provided or projected, e.g. on the head as indicated in FIG. 1 by the dashed circle. This light marking or pattern may be generated by a projection means P, e.g. by means of a specialized additional external frame projection unit, a modified ambient light source or the like.

Preferably, the (projected) light pattern is time and/or space variant (e.g. a gray coded light pattern). For example, it may change towards the area around the position detection device 9 or sensor device 1.

By evaluation of the sequence of light signals detected by the position detection device 9 at it's given position a position information relative to the position of the respective projection means P and/or any other position information can be derived.

The position detection can be based alternatively or additionally on magnetic field detection, e.g. the field of a marking or a field source or any other reference. For example, the position detection device 9 can comprise or contain a magnetic field detection unit and/or an adjustable magnetic field source. Preferably, each detection device 9 includes all necessary components for the filtering, signal decoding (e.g. “Matched-Filter”) and/or for the evaluation of the magnetic field in the surrounding of the respective detection device 9 or any sensor part thereof. Different scenarios of position detection schemes are possible, some of them will be described in the following.

One position detection device 9 having a magnetic field detection capability is preferably located in the centre of or within a group of position detection devices 9/sensor devices 1 containing a preferably adjustable or switchable magnetic field source. This arrangement is also shown in FIG. 1. In this case the dashed circle represents the position detection device 9 having a magnetic field detection capability. By sequentially switching the magnetic field source of each device on and off and by periodically and simultaneously measuring the direction and/or strength of the respective magnetic field by the position detection device 9 having a magnetic field detection capability, the relative position of each magnetic source and, thus, of the sensor devices 1 can be derived.

Similar detection schemes are possible by varying the modulation process of the filed source (e.g. using individual pseudo random codes as switching pattern for each source-device and matched filtering for each detection-device) and/or the timing and/or sequence parameters of periodic alternation of magnetic field sourcing and field detection (chain like or tree like detection process).

Particularly preferably, the sensor system or its receiving device 5, the display 6, another evaluation device, a computer or the like is configured in such a manner that the position or relative arrangement and/or configuration of the sensor devices 1 on the body 2 can be detected, monitored and/or displayed from the position data. In particular, it is provided that the sensor system can distinguish independently between a unipolar and bipolar lead or configuration. Accordingly, then the correct evaluation of the sensor signals by the sensor system or an associated evaluation, monitoring or the like can be made, preferably independently or in response to a corresponding confirmation by a user.

In particular, a discrimination between a unipolar and bipolar lead or configuration can thus be made, preferably independently by the sensor system.

As has already been mentioned, the detection of the position of the sensor devices 1 relative to one another permits an automatic identification and configuration of the arrangement, so that application errors can be avoided.

Alternatively or additionally, a continuous monitoring of the position data can be made. By this means, for example, a correction position of the sensor devices 1 on the body 2 can be monitored.

Particularly preferably, a plurality of or all the sensor devices 1 are configured for potential measurement and/or each provided with in particular only one electrode as sensor element 3. The sensor devices 1 are or will be electrically interconnected particularly as shown in FIG. 1 or 2 or in another suitable manner to bring about a common reference potential for the potential measurements. This reference potential is preferably controlled or regulated (subsequently for simplification only the terms “to control” or “control” will be used although regulation can alternatively be provided).

The control of the reference potential is preferably effected by one of the sensor devices 1, e.g. an amplifier device 7. In particular, the sensor devices 1 are configured in such a manner that in principle each can control the reference potential. This control by the individual sensor devices 1 can preferably be switched on and off or activated as desired, if required and/or by remote control (e.g. by the receiving device 5).

Alternatively or additionally it can also be provided that the first sensor device 1 which is switched on or logs onto the receiving device 5 or the sensor device 1 having the highest or lowest identifier or having the highest charging state of the energy storage device controls the reference potential.

The selection and/or activation of that sensor device 1 which controls the reference potential is preferably effected automatically or independently and/or by the receiving device 5.

The control of the reference potential is preferably effected taking into account the different potentials at the different sensor devices 1 or the potential fluctuations in such a manner that the amplifier devices 7 of the various sensor devices 1 are not, or only as little as possible, over-controlled. The desired reference potential is preferably specified by the sensor device 1 controlling the reference potential by cooperation of all the sensor devices 1 and/or by the receiving device 5 or an associated control device or the like.

The sensor devices 1 as proposed and the sensor system as proposed can be used universally and in particular for EEG, ECG, EOG and/or EMG measurements or investigations and for the leading-off of evoked potentials.

However, the sensor devices 1 and the sensor system can also be used for other purposes, for example, for the measurement and monitoring of blood pressure, pulse or oxygen content.

The solution as proposed permits non-place-bound monitoring of a “mobile” patient, particularly in the hospital environment. In particular, the solution as proposed allows medical measures to be transferred into the out-patient or home area. The sensor devices 1 as proposed are flexible and in particular self-organizing. The sensor devices 1 and the system as proposed permit continuous vital monitoring. A universally scalable system is achieved. The individual sensor devices 1 are coupled in a wireless manner to one another and to the preferably central receiving device 5. An arbitrary spatial separability of the components is thus made possible.

The cableless connection provided creates the necessary free space in the restricted working environment (e.g. in the ambulance or operating theatre) and permits near-sensor filtering, amplification and digitisation of the signals. Furthermore, the susceptibility to breakdown in the specific interference environment (e.g. the operating theatre) is hereby avoided or at least improved.

The sensor devices as proposed and the sensor system as proposed are suitable for many application scenarios such as continuous patient monitoring including integrated, automated handover procedures from the emergency EEG or ECG in the ambulance as far as into the operating theatre and up to post-operative monitoring in the intensive-care unit.

In generally it should be noted that the sensor devices 1 as proposed and the sensor system as proposed can be used universally.

What is claimed is:

1. A sensor device for in particular only external fastening to the human and/or animal body, comprising a sensor element and a transmission device for the wireless transmission of sensor signals to a receiving device, wherein additionally to the transmission device, the sensor device has a connecting device for cable-bound and/or electrical connection to a neighboring sensor device, particularly of the same type, in the state when attached to the body.

2. The sensor device according to claim 1, wherein the connecting device is configured for direct electrical connection to produce a common reference potential with the neighboring sensor device in the case of sensor devices attached to the human or animal body and/or fastened separately and/or spaced apart.

3. The sensor device according to claim 1, wherein the connecting device has a preferably non-detachable and/or retractable connecting cable and a connection for a connecting cable of another sensor device.

4. The sensor device according to claim 1, wherein the sensor device is configured for detecting connection data, namely the existence of a connection to the neighboring sensor device and in particular properties of the connection, in particular wherein the connection data can be transmitted from the transmitting device to the receiving device.

5. The sensor device according to claim 1, wherein the sensor device or its sensor element is configured for potential measurement and/or that the reference potential for the measurement, in particular for the potential measurement, can be controlled or regulated by the sensor device, in particularly for the neighboring sensor device.

6. The sensor device according to claim 1, wherein the sensor device has a position detection device, in particular wherein the position detection device is coupled to the connecting device or is formed by this.

7. The sensor device according to claim 6, wherein the position detection device is configured for active detection of the position, in particular distance and/or direction of the sensor device—preferably relative to a neighboring sensor device.

8. The sensor device according to claim 7, wherein the extension length and/or the direction of the connecting cable which is connected or can be connected to the neighboring sensor device can be detected by the position detection device.

9. The sensor device according to claim 6, wherein the position detection device is configured for passive detection of the position, in particular as a marking with defined properties.

10. A sensor device for in particular only external fastening to the human and/or animal body, comprising a sensor element, comprising a transmission device for the wireless transmission of sensor signals to a receiving device and comprising a position detection device, wherein the position detection device is configured for detecting the position of the sensor device relative to a neighboring sensor device or relative to marking.

11. The sensor device according to claim 10, wherein the length and/or the direction of a connecting cable which is connected or can be connected to the neighboring sensor device can be detected by the position detection device.

12. The sensor device according to claim 10, wherein the sensor device is configured for providing and in particular transmitting position data, which characterize the position of the respective sensor device, a neighboring sensor device and/or a reference point, to the receiving device.

13. A sensor device for in particular external fastening to the human and/or animal body, comprising a sensor element and a transmission device for preferably wireless transmission of sensor signals to a receiving device,
the sensor device is configured in such a manner that alternatively or additionally to the sensor element, an active device can be connected in particular for producing a stimulus.

14. The sensor device according to claim 13, wherein the active device is an actuator.

15. The sensor device according to claim 13, wherein the active device is a loudspeaker or sound generator.

16. The sensor device according to claim 1, wherein the sensor element is configured for measuring electrical, magnetic, acoustic and/or optical values or signals.

17. The sensor device according to claim 1, wherein the sensor element is configured as an electrode.

18. A sensor device for in particular external fastening to the human and/or animal body comprising an electrode as sensor element for potential measurement and comprising a transmission device for preferably wireless transmission of sensor signals to a receiving device, the sensor device is configured in such a manner that the reference potential can optionally be controlled or regulated for potential measurement.

19. The sensor device according to claim 1, wherein the sensor device forms a structural or handling unit especially with the sensor element and/or that the sensor element is detachable and/or exchangeable.

20. The sensor device according to claim 1, wherein various sensor elements can be connected to the sensor device and/or that respectively only a single sensor element can be connected concomitantly to the sensor device.

21. The sensor device according to claim 1, wherein the sensor device has an amplifier device for amplifying and/or processing signals of the sensor element, in particular wherein the amplified or processed signals can be transmitted as sensor signals in a wireless manner.

22. The sensor device according to claim 1, wherein the sensor device comprises an energy supply device, in particular an energy storage device, in particular wherein the energy storage device can be charged in a wireless manner, in particular inductively.

23. The sensor device according claim 1, wherein the sensor device has a fastening device (B) preferably additionally to the sensor element for in particular independent or separate fastening.

24. A sensor system comprising a receiving device and a plurality of at least one of the following sensor devices, for in particular only external fastening to the human and/or animal body:
a sensor device comprising a sensor element and a transmission device for the wireless transmission of sensor signals to a receiving device, wherein additionally to the transmission device, the sensor device has a connecting device for cable-bound and/or electrical connection to a neighboring sensor device, particularly of the same type, in the state when attached to the body and/or a sensor device comprising a sensor element, comprising a transmission device for the wireless transmission of sensor signals to a receiving device and comprising a position detection device, wherein the position detection device is configured for detecting the position of the sensor device relative to a neighboring sensor device or relative to a marking, and/or
a sensor device for in particular external fastening to the human and/or animal body, in particular according to one of the preceding claims, comprising a sensor element and a transmission device for preferably wireless transmission of sensor signals to a receiving device, wherein the sensor device is configured in such a manner that alternatively or additionally to the sensor element, an active device can be connected in particular for producing a stimulus, and/or
a sensor device for in particular external fastening to the human and/or animal body, in particular according to one of the preceding claims, comprising an electrode as sensor element for potential measurement and comprising a transmission device for preferably wireless transmission of sensor signals to a receiving device, wherein the sensor device is configured in such a manner that the reference potential can optionally be controlled or regulated for potential measurement.

25. The sensor system according to claims 24, wherein the reference potential for the potential measurements for some or all the sensor devices can be controlled or regulated by one of the sensor devices.
